(19) United States
(12) Patent Application Publication
(10) Pub. No.: US 2012/0162226 A1
(43) Pub. Date: Jun. 28, 2012

(54) FRACTURE PATTERN GENERATION APPARATUS AND METHOD FOR CRUMBLING EFFECT

(75) Inventors: Seung-Hyup SHIN, Daejeon (KR); Soon-Hyoung PYO, Daejeon (KR); Bon-Ki KOO, Daejeon (KR)

(73) Assignee: Electronics and Telecommunications Research Institute, Daejeon (KR)

(21) Appl. No.: 13/331,868

(22) Filed: Dec. 20, 2011

(30) Foreign Application Priority Data
Dec. 22, 2010 (KR) 10-2010-0132881
Apr. 14, 2011 (KR) 10-2011-0034742

(51) Int. Cl. G06T 17/20

(52) U.S. Cl. 345/423

(57) ABSTRACT

Disclosed herein is a fracture pattern generation apparatus for a crumbling effect includes a graph generation unit, a fragment center setting unit, a fracture pattern generation unit, and a fragment mesh generation unit. The graph generation unit generates the graph of the mesh model by filling the inside of a mesh model with a plurality of vertices and connecting the vertices using line segments. The fragment center setting unit sets the central vertices of fragments, which are separated due to fractures, from among the plurality of vertices formed on the graph. The fracture pattern generation unit generates the fracture pattern by setting the central vertices of the fragments to terminal vertices of the fracture pattern and allocating Identifications (IDs) to the respective the central vertices of fragments. The fragment mesh generation unit generates fragment meshes by performing division on the graph based on the fracture pattern.

### CROSS REFERENCE TO RELATED APPLICATIONS

This application claims the benefit of Korean Patent Application No. 10-2010-0132881, filed on Dec. 22, 2010, and Korean Patent Application No. 10-2011-0034742, filed on Apr. 14, 2011, which are hereby incorporated by reference in their entirety into this application.

### BACKGROUND OF THE INVENTION

1. Technical Field

The present invention relates generally to a fracture pattern generation apparatus and method for a crumbling effect, and, more particularly, to a fracture pattern generation apparatus and method for a crumbling effect, which generates the fracture pattern of an object in order to realistically express a crumbling effect in 3-dimensional (3D) animation.

2. Description of the Related Art

Recently, the importance of visual special effects in digital content, such as movies or animation, has increased. In particular, expressing the fractures of an object is an element which is essential for realistically showing explosion or destruction scenes. A technique for modeling and visualizing such a fracture using computer simulation has big advantages in terms of expense and safety, and so has substituted for a considerable portion of the existing method in which miniatures or real-sized sets are built and destruction scenes are actually carried out.

When fractures are modeled, it is important that a fracture pattern be realistic and that the intention of an animator be accurately and easily portrayed. However, in reality, existing fracture modeling methods generally put emphasis on one of realism and fabrication.

O′brien and Hodgins proposed a technique for simulating a process in which fractures start and then the fractures are expanded into a 3D space. They realistically simulated fractures which occur due to internal stress which is generated when impact is applied to an input mesh and then the mesh is transformed. This technique has the advantage of obtaining highly accurate results. However, a large amount of computation is required in the process of simulating the generation of fractures based on the dispersion of real power.

Meanwhile, Sukumar defines the virtual vertices inside an object, and calculates a Voronoi diagram based on the virtual vertices, thereby expressing the crumbling of an object. This method allows a user to perform fast and easy manipulation, and so has been the one the most applied to real production. However, this method has the disadvantages in that there are not a variety of shapes of the fractures, and that it is difficult to express asymmetrical fractures.

### SUMMARY OF THE INVENTION

Accordingly, the present invention has been made keeping in mind the above problems occurring in the prior art, and an object of the present invention is to provide a fracture pattern generation apparatus and method for a crumbling effect which generates high quality of fracture patterns, generated from various types of uniform and non-uniform objects.

Another object of the present invention is to provide a fracture pattern generation apparatus and method for a crumbling effect which supports a user to intuitively manipulate the dispersion of fragment clusters, the randomness of the shapes of the fractures, and the degree of roughness.

Still another object of the present invention is to provide a fracture pattern generation apparatus and method for a crumbling effect which enables 3D fragment models, which are obtained as the results, to be combined with an existing rigid simulation system, thereby being used to manufacture realistic fracture scenes.

In order to accomplish the above objects, the present invention provides a fracture pattern generation apparatus for a crumbling effect, including: a graph generation unit for generating the graph of the mesh model by filling the inside of a mesh model, which is used for generating a fracture pattern, with a plurality of vertices and connecting the vertices using line segments; a fragment center setting unit for setting the central vertices of fragments, which are separated due to fractures, from among the plurality of vertices formed on the graph; a fracture pattern generation unit for generating the fracture pattern by setting the central vertices of the fragments to terminal vertices of the fracture pattern and allocating Identifications (IDs) to the respective the central vertices of fragments; and a fragment mesh generation unit for generating fragment meshes by performing division on the graph based on the fracture pattern.

The graph generation unit may fill the inside of the mesh model with the plurality of vertices using uniform grid points.

The graph generation unit may fill the inside of the mesh model with the plurality of vertices by generating the vertices at random points.

The graph generation unit may adjust the positions of the respective vertices and the density of the vertices by detecting the density of the vertices that fill the inside of the mesh model.

The fracture pattern generation apparatus may further include a line segment weight setting unit for setting weights to the respective line segments in order to perform partition on the graph.

The fracture pattern generation unit may calculate a value, which is used for generating the fracture pattern, using a multi-way graph-cut technique.

The fragment mesh generation unit may generate the set of the fragment meshes.

Meanwhile, in order to accomplish the above objects, the present invention provides a fracture pattern generation method for a crumbling effect, including generating the graph of the mesh model by filling the inside of a mesh model, which is used for generating a fracture pattern, with a plurality of vertices and connecting the vertices using line segments; setting the central vertices of fragments, which are separated due to fractures, from among the plurality of vertices formed on the graph; generating the fracture pattern by setting the central vertices of the fragments to terminal vertices of the fracture pattern and allocating IDs to the respective the central vertices of fragments; and generating fragment meshes by performing division on the graph based on the fracture pattern.

The generating the graph may include filling the inside of the mesh model with the plurality of vertices using uniform grid points.

The generating the graph may include filling the inside of the mesh model with the plurality of vertices by generating the vertices at random points.

The generating the graph may include adjusting positions of the respective vertices and the density of the vertices by detecting the density of the vertices that fill the inside of the mesh model.

The fracture pattern generation method may further include setting weights to the respective line segments in order to perform partition on the graph.

The generating the fracture pattern may include calculating a value, which is used for generating the fracture pattern, using a multi-way graph-cut technique.

The generating the fracture pattern may include generating the set of the fragment meshes.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of a fracture pattern generation apparatus for a crumbling effect according to the present invention;

FIG. 2 is a view illustrating an example of a mesh model which is input to the fracture pattern generation apparatus for a crumbling effect according to the present invention;

FIG. 3 is a view illustrating an example of an operation of generating a graph using the fracture pattern generation apparatus for a crumbling effect according to the present invention;

FIG. 4 is a view illustrating an example of an operation of selecting the centers of fragments using the fracture pattern generation apparatus for a crumbling effect according to the present invention;

FIG. 5 is a view illustrating an example of an operation of generating a fracture pattern using the fracture pattern generation apparatus for a crumbling effect according to the present invention;

FIGS. 6 to 8 are views illustrating an operation of generating fracture meshes; and

FIG. 9 is a flowchart illustrating the flow of the operations of a fracture pattern generation method for a crumbling effect according to the present invention.

### DESCRIPTION OF THE PREFERRED EMBODIMENTS

Embodiments of the present invention will be described with reference to accompanying drawings below.

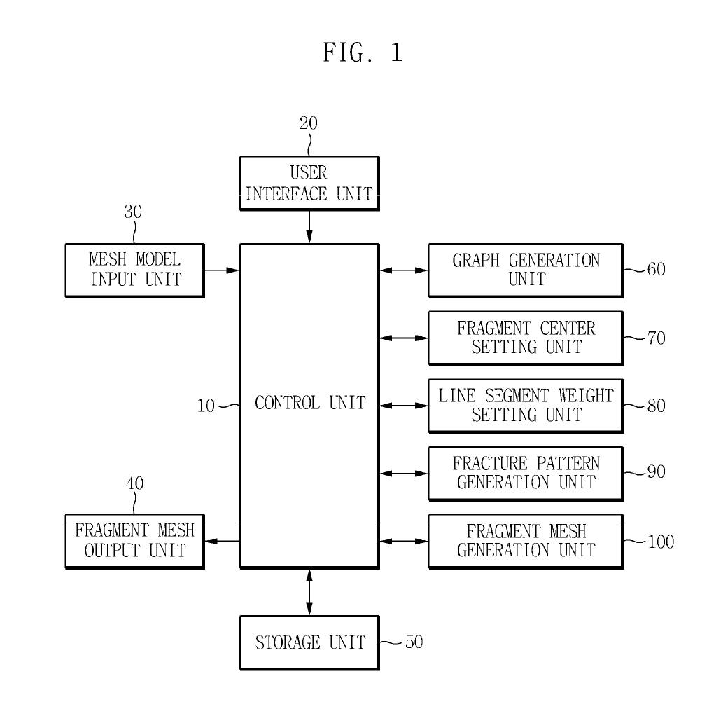

FIG. 1 is a block diagram illustrating the configuration of a fracture pattern generation apparatus for a crumbling effect according to the present invention.

As shown in FIG. 1, the fracture pattern generation apparatus for a crumbling effect according to the present invention includes a control unit 10, a user interface unit 20, a mesh model input unit 30, a fragment mesh output unit 40, a storage unit 50, a graph generation unit 60, a fragment center setting unit 70, a line segment weight setting unit 80, a fracture pattern generation unit 90, and a fragment mesh generation unit 100. Here, the control unit 10 controls the operation of each of the units of the fracture pattern generation apparatus.

The user interface unit 20 receives a control command from a user. Here, the user interface unit 20 receives a user command indicative of selection of vertices or setting of the weights of line segments.

The mesh model input unit 30 receives a mesh model used for generating a fracture pattern. Here, the mesh model is received in the form of 3D triangle meshes. Further, it is assumed that the mesh model corresponds to a 2D manifold, that is, the topology of adjacent positions is in the shape of a disc at any position on a surface. Therefore, a single line segment is guaranteed to come into contact with two surfaces and there is not a case where two surfaces overlap each other (self-penetration) or come into contact with each other.

The fragment mesh output unit 40 outputs resulting meshes generated using the fragment mesh generation unit 100 with respect to the mesh model input to the mesh model input unit 30.

The storage unit 50 stores the mesh model and information about the mesh model received from the mesh model input unit 30. Further, the storage unit 50 stores setting values and resulting values based on the operation of the fracture pattern generation apparatus.

The graph generation unit 60 generates a graph based on the mesh model received using the mesh model input unit 30. Here, the graph generation unit 60 first fills the inside of the input mesh model with a plurality of vertices, and connects each of the vertices to neighboring vertices using line segments, thereby generating a graph structure. Here, the graph generation unit 60 may fill the inside of the mesh model with the plurality of vertices using uniform grid points or random points.

When vertices are generated on random points, it is difficult to uniformly maintain the density of vertices and the quality of the fracture pattern may deteriorate. Therefore, the graph generation unit 60 repeatedly performs the process of relaxing the position p(x) of each of the vertices x generated on random points using the following Equation 1.

$$p ( x ) = {\sum }_{{n}_{i} ∈ N} p ( {n}_{i} ) w ( \vert x - {n}_{i} \vert ) \qquad ( 1 )$$

where N indicates neighboring vertices of a vertex x, and w(|x−nᵢ|) indicates a Gaussian kernel function.

The graph generation unit 60 fixes vertices which get out of the mesh model to their original positions by performing the process of relaxing the position of each of the vertices.

Here, vertices on the mesh model and vertices newly filled into the inside of the mesh model are included in a set and the set is referred to as a set V. When the vertices on the mesh model are distributed at a density which is lower than the density of the vertices newly filled into the inside of the mesh model, additional vertices are generated on the surface of the mesh model. Here, the process of generating additional vertices in the centers of the respective triangles of the mesh model is recursively performed until the density of the vertices on the mesh model reaches the desired density.

Thereafter, the graph generation unit 60 connects the vertices of the set V using line segments, thereby generating a graph G=G(V,E), where E indicates a set of line segments which connect vertices.

When each of the line segments is defined, the following two conditions should be satisfied:

1) The line segment should be included in the inside of the mesh model.

2) Only neighboring vertices should be connected using line segments.

The Constrained Delaunay Triangulation (CDT) technique is used in the present invention in order to satisfy the first and second conditions.

When the graph is generated based on the mesh model, the fragment center setting unit 70 sets the central vertices of respective fragments which are separated due to fracture. In the embodiment of the present invention, some of the vertices of the graph are selected and set to the centers of the respective fragments.

Here, a method of selecting the central vertices of the respective fragments from among the vertices within the mesh model may include any of an automated random selection method, a user selection method, and a method of automatically selecting vertices and then additionally editing the vertices by a user. When one or more vertices are selected using one of the above-described methods, the fragment center setting unit 70 sets the selected vertices to the central vertices of fragments.

The line segment weight setting unit 80 allocates weight to each of the line segments in order to convert a problem of generating a fracture pattern into a problem of performing division on the graph.

Generally, any value may be the weight of a line segment. Here, the line segment weight setting unit 80 first applies the Radial Basis Function (RBF), expressed in the following Equation 2, to a weight function in order to guarantee that uniform sized fragment clusters are generated based on the central vertices of the respective fragments.

$$Gaussian ( x ) = {e}^{- \frac{{( x - b )}^{2}}{2 {c}^{2}}} \qquad ( 2 )$$

where x indicates the position of each vertex, b indicates the position of the central vertex of each fragment, and c indicates the distance between the furthest vertices.

Further, the line segment weight setting unit 80 secondly defines a noise function in order to express the randomness around fractures. In the embodiment of the present invention, the Perlin noise function, which is the most widely used, is used as the noise function. It is apparent that the Fractional Brownian Motion (FBM) function and the fractal function may be used as the noise function as well as the Perlin noise function, and the noise function may be freely selected depending on the properties of the matter of the object which is the target of destruction.

At last, the line segment weight setting unit 80 sets a line segment weight using the first weight function and the second noise function. The weighted sum of the first weight function and the second noise function is expressed as the following Equation 3:

$$w ( x ) = {\sum }_{b} \{ Gaussian ( x , b ) + Noise ( x ) \} \qquad ( 3 )$$

In order to guarantee the minimum size of each of the fragments, vertices (1-neighbor) which are directly connected to each of the central vertices of the fragments should not be separated from each other when division is performed on a graph. Therefore, the line segment weight setting unit 80 sets infinite weights to line segments which connect vertices neighboring on each of the central vertices of the fragments, thereby preventing the line segments from being separated from each other when division is performed on the graph.

When division is performed on the graph using the radial basis function and the Perlin noise function as described above, generating results, which would be similar to those of the fracture pattern generation method based on the Voronoi diagram which has been frequently used before, can be prevented.

Meanwhile, since there may be a plurality of central vertices of the fragments, a problem of performing division on a graph returns to a problem of performing multiple labeling, in which neighboring vertices are bound based on each of the central vertices of the fragments.

Therefore, the fracture pattern generation unit 90 obtains a value, used for generating the fracture pattern, using a multi-way graph-cut technique. Here, the fracture pattern generation unit 90 designates each of the central vertices of the fragments as the terminal vertex of the fracture pattern, and allocates a label Identification (ID) to each of the central vertices of the fragments.

The obtainment of the accurate values of the multi-way graph-cut has been known as a Non-deterministic Polynomial-time hard (NP-hard) problem and a large amount of computation is required. However, since it is not required to perform accurate division on the graph in the embodiment of the present invention, it is preferable to find an approximate value and the α-expansion algorithm, such as Boykov, is used.

The fragment mesh generation unit 100 generates fragment meshes based on the graph on which division was performed.

For this purpose, the fragment mesh generation unit 100 first obtains all the tetrahedrons including line segments which were separated using the graph-cut technique. Here, the obtained tetrahedrons (triangles in 2-dimensions) are partitioned into fragments, thereby satisfying a space partition condition in which each of the fragment meshes is accurately separated from each other while the fragment meshes do not overlap each other and there are no gaps between the fragment meshes.

Meanwhile, when vertices are added to the surface of the input meshes in the graph generation step, the fragment mesh generation unit 100 may generate simplified fragment meshes by removing the added vertices.

The fragment mesh generation unit 100 generates a set of each of the fragment meshes. Here, the fragment mesh generation unit 100 outputs the set of each of the fragment meshes using the fragment mesh output unit 40.

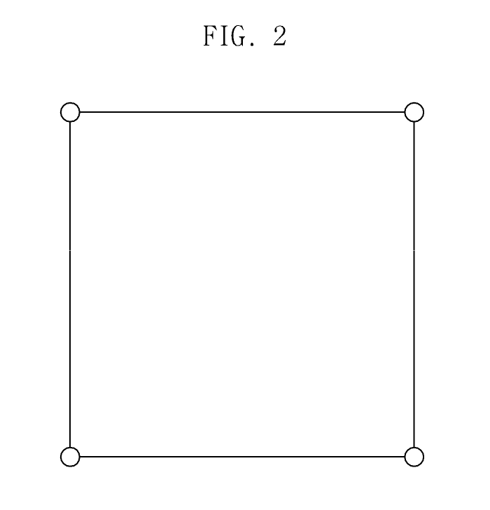

FIG. 2 is a view illustrating an example of a mesh model which is input to the fracture pattern generation apparatus for a crumbling effect according to the present invention.

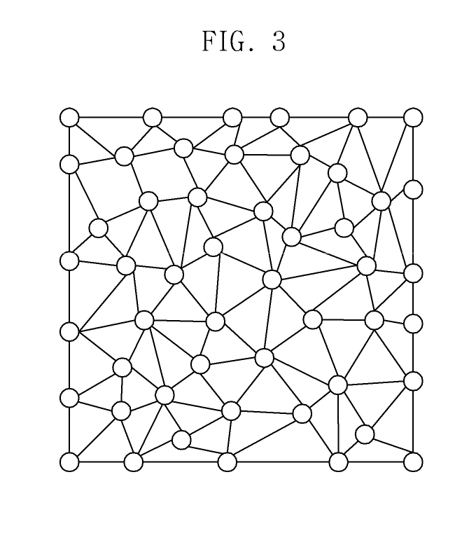

As shown in FIG. 2, the 2D mesh model includes four vertices and four line segments which connect each of the vertices. The 2D mesh model, shown in FIG. 2, passes through the processes of FIGS. 3 to 8, thereby generating final fragment meshes.

FIG. 3 is a view illustrating an example of an operation of generating a graph using the fracture pattern generation apparatus for a crumbling effect according to the present invention

First, the fracture pattern generation apparatus fills the inside of the mesh model, which was input to generate a graph, with a plurality of vertices. Here, the fracture pattern generation apparatus may fill the inside of the mesh model with vertices using uniform grid points or may fill the inside of the mesh model with the vertices at random points. It is apparent that the fracture pattern generation apparatus may adjust the positions of the vertices and the density of the vertices using Equation 1 when the fracture pattern generation apparatus fills the inside of the mesh model with vertices at random points.

Thereafter, the fracture pattern generation apparatus generates a graph by connecting each of the vertices to neighboring vertices using line segments. Here, line segments formed the outside of the mesh model are excepted from the graph.

The graph of the mesh model generated as described above is shown in FIG. 3.

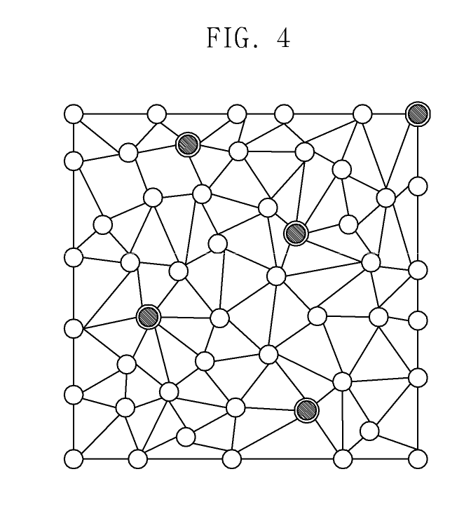

FIG. 4 is a view illustrating an example of an operation of selecting the centers of fragments using the fracture pattern generation apparatus for a crumbling effect according to the present invention.

When the graph of the mesh model is generated as shown in FIG. 3, the fracture pattern generation apparatus separates each of the fragments which are separated by fractures.

Thereafter, the fracture pattern generation apparatus sets the central point of each of the fragments which are separated by fractures, that is, the central vertices of the fragments from among the vertices on the graph shown in FIG. 3.

The central vertices of the fragments, which were set as described above, are shown in FIG. 4.

Here, a method of setting the central vertices of fragments is not limited to any one method and various methods, such as an automated random selection method, a user selection method, and a method of automatically selecting vertices and then additionally editing the vertices by a user, may be used.

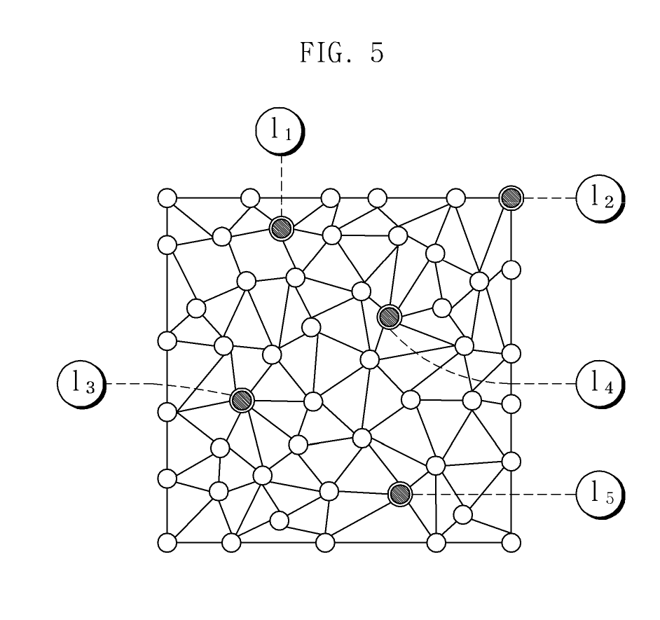

FIG. 5 is a view illustrating an example of an operation of generating a fracture pattern using the fracture pattern generation apparatus for a crumbling effect according to the present invention.

The fracture pattern generation apparatus generates a fracture pattern based on the central vertices of the fragments where were set in FIG. 4. Here, the fracture pattern generation apparatus obtains a value, used for generating the fracture pattern, using the multi-way graph-cut technique. Here, the fracture pattern generation apparatus obtains a value, used for generate the fracture pattern, using an α-expansion algorithm such as Boykov.

Since it is not required that accurate division be performed on the graph in the present invention, it is sufficient to find an approximate value even though an accurate value is not found.

Further, the fracture pattern generation apparatus designates each of the central vertices of the fragments as the terminal vertex of the fracture pattern, and allocates a label ID (i.e., l₁, l₂, l₃, l₄ and l₅) to each of the central vertices of the fragments as shown in FIG. 5.

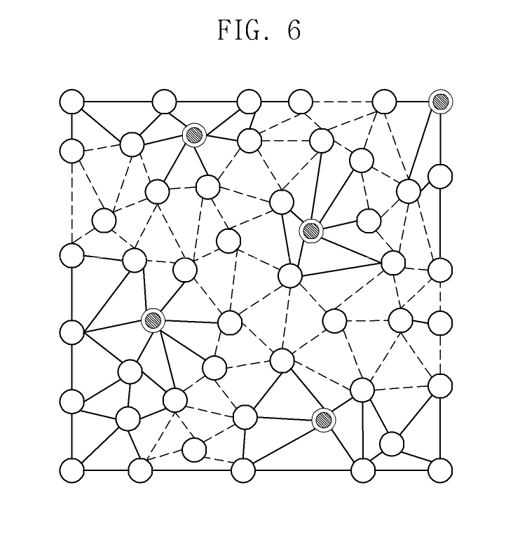

FIGS. 6 to 8 are views illustrating an example of an operation of generating fragment meshes.

First, FIG. 6 is a view illustrating an operation of performing partition on line segments using the multi-way graph-cut technique. As shown in FIG. 6, the fracture pattern generation apparatus performs partition on line segments using the value obtained by the operation of FIG. 5. The resulting line segments obtained through the partition are displayed in FIG. 6 using dotted lines.

Here, the fracture pattern generation apparatus obtains all tetrahedrons including the line segments separated by the multi-way graph-cut technique.

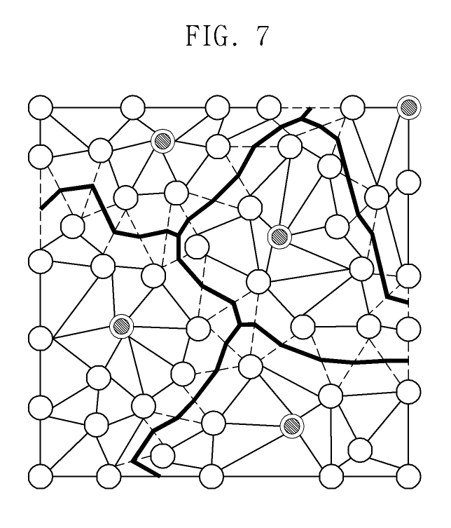

Thereafter, the fracture pattern generation apparatus performs partition on the obtained triangles such that each of the fragment meshes does not overlap with another fragment mesh and there are no gaps between the fragment meshes, thereby satisfying space partition conditions. Here, the fracture pattern generation apparatus obtains line segments used for performing partition on the fragment meshes by connecting the central points of the obtained triangles as shown in FIG. 7.

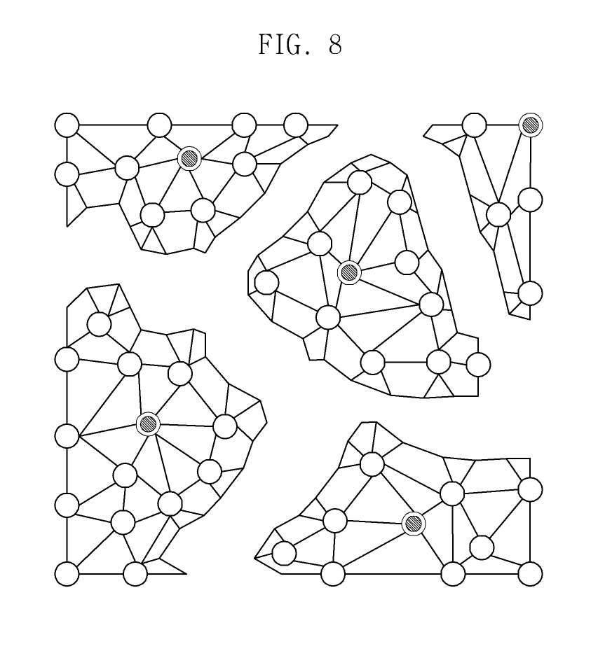

Therefore, the fracture pattern generation apparatus performs partition on the line segments, obtained by connecting the central points of the triangles, thereby obtaining fragment meshes obtained through partition as shown in FIG. 8, and generating a set of each of the fragment meshes.

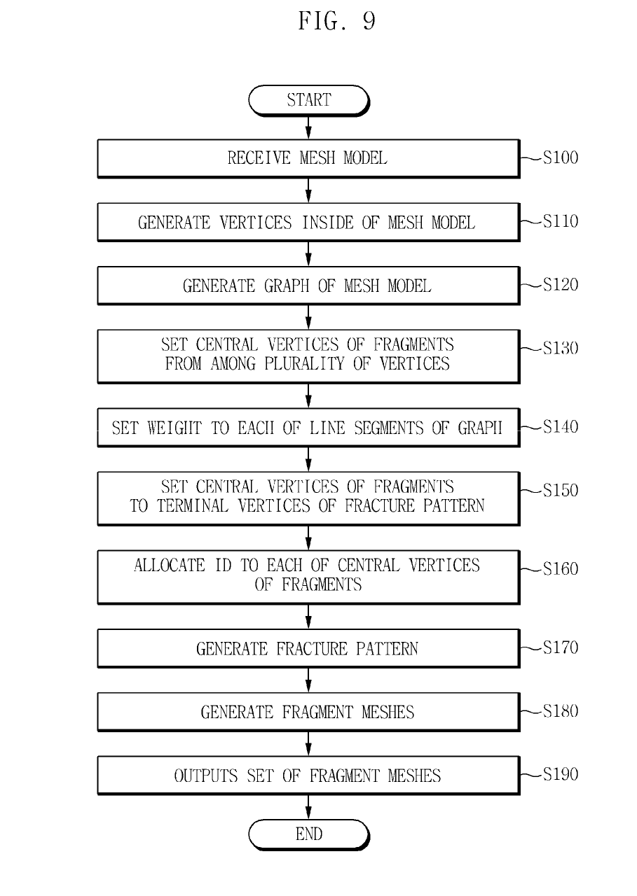

FIG. 9 is a flowchart illustrating the flow of the operations of a fracture pattern generation method for a crumbling effect according to the present invention.

Referring to FIG. 9, when the fracture pattern generation apparatus according to the present invention receives a mesh model at step S100, the fracture pattern generation apparatus generates a plurality of vertices in the inside of the mesh model at step S110. Here, the fracture pattern generation apparatus generates the graph structure of the corresponding mesh model by connecting the plurality of vertices, generated at step S100, using line segments at step S120.

Further, the fracture pattern generation apparatus sets the central vertices of fragments which are separated due to fractures from among the plurality of vertices, generated at step S110, at step S130.

The fracture pattern generation apparatus sets a weight to each of the line segments of the graph such that uniform sized fragment clusters are generated based on the central vertices of the fragments at step S140. Further, the fracture pattern generation apparatus sets the central vertices of the fragments, set at step S130, to the terminal vertices of a fracture pattern at step S150, and allocates an ID to each of the central vertices of the fragments at step S160.

Thereafter, the fracture pattern generation apparatus generates the fracture pattern based on values, set at steps S140 to S160, at step S170.

The fracture pattern generation apparatus generates fragment meshes of the mesh model based on the fracture pattern, generated at step S170, at step S180. Here, the fragment meshes may be generated by performing division on the graph, generated at step S120, based on the fracture pattern.

Finally, the fracture pattern generation apparatus outputs a set of the fragment meshes at step S190, and ends the corresponding operation.

The present invention has the advantages as follows:

1) The dispersion of fragments, the size of each of the fragments, the shape of a fraction surface, and the degree of the roughness of the fracture surface can be adjusted based on the intention of a user in consideration of the properties of the matter of a 3D object.

2) A further general value may be obtained, compared to the existing Voronoi diagram—based technique which has been frequently used for production, and an asymmetric fracture pattern may be generated using a noise function.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A fracture pattern generation apparatus for a crumbling effect, comprising:
a graph generation unit for generating a graph of a mesh model by filling an inside of the mesh model, which is used for generating a fracture pattern, with a plurality of vertices and connecting the vertices using line segments;
a fragment center setting unit for setting central vertices of fragments, which are separated due to fractures, from among the plurality of vertices formed on the graph;
a fracture pattern generation unit for generating the fracture pattern by setting the central vertices of the fragments to terminal vertices of the fracture pattern and allocating Identifications (IDs) to the respective central vertices of fragments; and
a fragment mesh generation unit for generating fragment meshes by performing division on the graph based on the fracture pattern.

2. The fracture pattern generation apparatus as set forth in claim 1, wherein the graph generation unit fills the inside of the mesh model with the plurality of vertices using uniform grid points.

3. The fracture pattern generation apparatus as set forth in claim 1, wherein the graph generation unit fills the inside of the mesh model with the plurality of vertices by generating the vertices at random points.

4. The fracture pattern generation apparatus as set forth in claim 1, wherein the graph generation unit adjusts positions of the respective vertices and a density of the vertices by detecting the density of the vertices that fill the inside of the mesh model.

5. The fracture pattern generation apparatus as set forth in claim 1, further comprising a line segment weight setting unit for setting weights to the respective line segments in order to perform partition on the graph.

6. The fracture pattern generation apparatus as set forth in claim 1, wherein the fracture pattern generation unit calculates a value, which is used for generating the fracture pattern, using a multi-way graph-cut technique.

7. The fracture pattern generation apparatus as set forth in claim 1, wherein the fragment mesh generation unit generates a set of the fragment meshes.

8. A fracture pattern generation method for a crumbling effect, comprising:
generating a graph of the mesh model by filling an inside of a mesh model, which is used for generating a fracture pattern, with a plurality of vertices and connecting the vertices using line segments;
setting central vertices of fragments, which are separated due to fractures, from among the plurality of vertices formed on the graph;
generating the fracture pattern by setting the central vertices of the fragments to terminal vertices of the fracture pattern and allocating Identifications (IDs) to the respective central vertices of fragments; and
generating fragment meshes by performing division on the graph based on the fracture pattern.

9. The fracture pattern generation method as set forth in claim 8, wherein the generating the graph comprises filling the inside of the mesh model with the plurality of vertices using uniform grid points.

10. The fracture pattern generation method as set forth in claim 8, wherein the generating the graph comprises filling the inside of the mesh model with the plurality of vertices by generating the vertices at random points.

11. The fracture pattern generation method as set forth in claim 8, wherein the generating the graph comprises adjusting positions of the respective vertices and a density of the vertices by detecting the density of the vertices that fill the inside of the mesh model.

12. The fracture pattern generation method as set forth in claim 8, further comprising setting weights to the respective line segments in order to perform partition on the graph.

13. The fracture pattern generation method as set forth in claim 8, wherein the generating the fracture pattern comprises calculating a value, which is used for generating the fracture pattern, using a multi-way graph-cut technique.

14. The fracture pattern generation method as set forth in claim 8, wherein the generating the fracture pattern comprises generating a set of the fragment meshes.
